(19) United States
(12) Patent Application Publication
(10) Pub. No.: US 2010/0205381 A1
(43) Pub. Date: Aug. 12, 2010

(54) System and Method for Managing Memory in a Multiprocessor Computing Environment

(76) Inventor: Rodney S. Canion, West Lake Hills, TX (US)

Correspondence Address: Baker Botts L.L.P, 910 Louisiana Street, One Shell Plaza, HOUSTON, TX, 77002, US

(21) Appl. No.: 12/367,138

(22) Filed: Feb. 6, 2009

(51) Int. Cl. G06F 12/00; G06F 9/46

(52) U.S. Cl. 711/147; 718/100; 711/E12.001

(57) ABSTRACT

A method for managing a memory communicatively coupled to a plurality of processors may include analyzing a data structure associated with a processor to determine if one or more portions of memory associated with the processor are sufficient to store data associated with an operation of the processor. The method may also include storing data associated with the operation in the one or more portions of the memory associated with the processor if the portions of memory associated with the processor are sufficient. If the portions of memory associated with the processor are not sufficient, the method may include determining if at least one portion of the memory is unassociated with any of the plurality of processors storing data associated with the operation in the at least one unassociated portion of the memory.

### BACKGROUND

1. Field of the Present Invention

The present invention generally relates to the field of data communication systems and networks and, more particularly, devices designed for processing packet switched network communication.

2. History of Related Art

A network processor generally refers to one or more integrated circuits having a feature set specifically targeted at the networking application domain. In contrast to general purpose central processing units (CPUs), network processors are special purpose devices designed to perform a specified task or group of related tasks efficiently.

The majority of modern telecommunications networks are referred to as packet switching networks in which information (voice, video, data) is transferred as packet data rather than as the analog signals that were used in legacy telecommunications networks, sometimes referred to as circuit switching networks, such as the public switched telephone network (PSTN) or analog TV/Radio networks. Many protocols that define the format and characteristics of packet switched data have evolved. In many applications including the Internet and conventional Ethernet local area networks, multiple protocols are employed, typically in a layered fashion, to control different aspects of the communication process. Some protocols layers include the generation of data (e.g., a checksum or CRC code) as part of the network processing.

Historically, the relatively low volume of traffic and the relatively low speeds or data transfer rates of the Internet and other best-efforts networks were not sufficient to place a significant packet processing burden on the CPU of a network attached device. However, the recent enormous growth in packet traffic combined with the increased speeds of networks enabled by Gigabit and 10 Gigabit Ethernet backbones, Optical Carriers, and the like have transformed network processing into a primary consideration in the design of network devices. For example, Gigabit TCP (transmission control protocol) communication would require a dedicated 2.4 MHz Pentium® class processor just to do software-implemented network processing. Network processing devices have evolved as a necessity for offloading some or all of the network processing overhead from the CPU to specially dedicated devices. These dedicated devices may be referred to herein as network processors.

Network processing devices, like traditional CPUs, can employ one or more of numerous approaches to increase performance. One such approach is multithreading. Multithreading occurs where a single CPU or network processing device includes hardware to efficiently execute multiple threads, often simultaneously or in parallel. Each thread may be thought of a different fork in a program of instructions, or different portions of a program of instructions. By executing various threads simultaneously or in parallel, execution time of processing operations may be reduced.

Another approach to increase performance is multiprocessing. Multiprocessing is the use of two or more CPUs or network processing devices within a single computer system and the allocation of threads or tasks among the plurality of processors in order to reduce the execution time of processing operations. As used herein, multiprocessing refers to the allocation of tasks to a plurality of processing units, whether each such processing unit is a separate device (e.g., each different processing unit in its own integrated circuit package, a “monolithic” processor), whether such plurality of processing units are part of the same device (e.g., each processing unit is a “core” within a “dual core,” “quad core,” or other multicore processor), or some combination thereof (e.g., a computer system with multiple quad core processors).

Unfortunately, under traditional approaches to multithreading and multiprocessing, performance may not necessarily increase linearly with the number of processing units or threads. For example, processing units often utilize buffers and buffer pools. A buffer is a region of memory that may temporarily store data while it is being communicated from one place to another in a computing system, and a buffer pool, is a collection of a plurality of such buffers. However, in a multithreading or multiprocessing implementation, the various threads may desire to access the same buffer pool, thus creating “contention.” When a contention occurs, only one thread may have access to the buffer pool in essence locking out the other threads. Unable to access the buffer pool, these locked-out threads may have to stall execution, thus decreasing individual thread performance. Because the likelihood of contention increases as the number of threads increases, performance does not increase linearly with the number of threads, at least not using traditional approaches.

One potential solution would be to split buffer storage space into a plurality of different buffer pools such that each thread or processor is assigned at least one dedicated buffer pool. However, this solution may be less than ideal, as buffer pools dedicated to threads or processors not requiring a significant volume of buffer space are essentially “wasted,” and thread or processors requiring a substantially significant volume of buffer space may need more buffer space than is allocated to such thread or processor.

### SUMMARY OF THE INVENTION

In accordance with the teachings of the present disclosure, the disadvantages and problems associated with multithreading and multiprocessing may be reduced or eliminated.

In accordance with one embodiment of the present disclosure, a system may include a plurality of processors and a memory communicatively coupled to each of the plurality of processors. The memory may have a plurality of portions, and each portion may have a marker indicative of whether such portion is associated with one of the plurality of processors. At least one of the plurality of processors may be configured to maintain an associated data structure, the data structure indicative of the portions of the memory associated with the processor.

In accordance with another embodiment of the present disclosure, a method for managing a memory communicatively coupled to a plurality of processors is provided. The method may include analyzing a data structure associated with a processor to determine if one or more portions of memory associated with the processor are sufficient to store data associated with an operation of the processor. The method may also include storing data associated with the operation in the one or more portions of the memory associated with the processor if the portions of memory associated with the processor are sufficient. If the portions of memory associated with the processor are not sufficient, the method may include determining if at least one portion of the memory is unassociated with any of the plurality of processors storing data associated with the operation in the at least one unassociated portion of the memory.

In accordance with a further embodiment of the present disclosure, a network processor may be configured to be communicatively coupled to at least one other network processor and a memory. The network processor may also be configured to analyze a data structure associated with the network processor to determine if one or more portions of memory associated with the network processor are sufficient to store data associated with an operation of the network processor and store data associated with the operation in the one or more portions of the memory associated with the network processor if the portions of memory associated with the network processor are sufficient. If the portions of memory associated with the network processor are not sufficient, the network processor may be further configured to determine if at least one portion of the memory is unassociated with any of the at least one other network processor and store data associated with the operation in the at least one unassociated portion of the memory.

Other technical advantages will be apparent to those of ordinary skill in the art in view of the following specification, claims, and drawings.

### BRIEF DESCRIPTION OF THE DRAWINGS

Objects and advantages of the invention will become apparent upon reading the following detailed description and upon reference to the accompanying drawings in which:

FIG. 1 illustrates a block diagram of selected elements of an example data processing system showing a network attached device coupled to a network, in accordance with embodiments of the present disclosure;

FIGS. 2A-2C each illustrate a block diagram of selected elements of example network attached devices, in accordance with embodiments of the present disclosure;

FIG. 3 illustrates a block diagram of selected elements of an example memory, in accordance with embodiments of the present disclosure;

FIG. 4 illustrates a flow chart of an example method for accessing a buffer pool by a processor, in accordance with embodiments of the present disclosure; and

FIG. 5 illustrates a flow chart of an example method for freeing a buffer pool by a processor, in accordance with embodiments of the present disclosure.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the invention is limited only by the language of the appended claims.

### DETAILED DESCRIPTION OF THE INVENTION

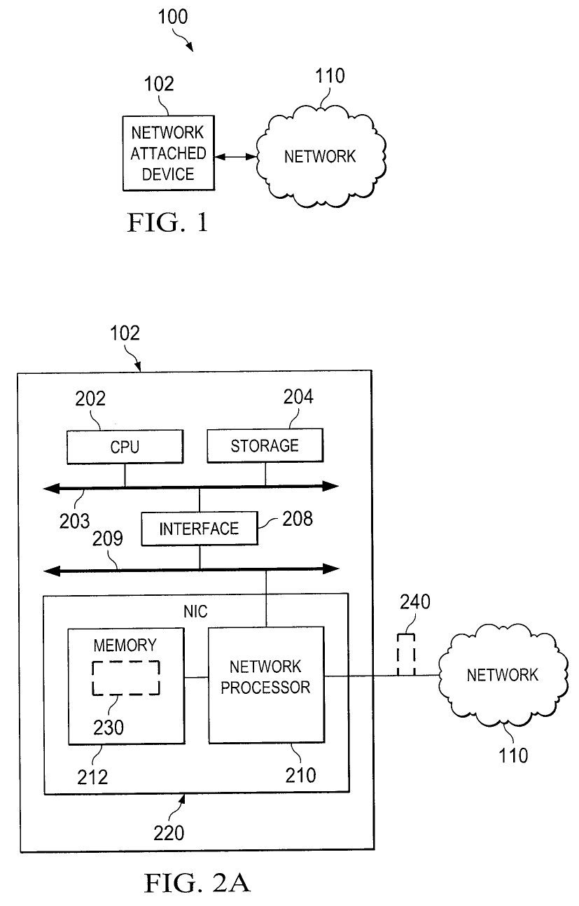

Embodiments of their the present disclosure and their advantages are best understood by reference to FIGS. 1-5, wherein like numbers are used to indicate like and corresponding parts.

FIG. 1 illustrates a block diagram of selected elements of an example data processing system 100 showing a network attached device 102 coupled to a network 110, in accordance with embodiments of the present disclosure. As suggested by its name, network attached device 102 may include any of a wide variety of network aware devices. Network attached device 102 may be implemented as a server class, desktop, or laptop computer. In other embodiments, network attached device 102 may be implemented as a stand alone network device such as a gateway, network router, network switch, or other suitable network device. Similarly, network 110 may include Ethernet and other familiar local area networks as well as various wide area networks including the Internet. Network 110 may include, in addition to one or more physical network medium, various network devices such as gateways, routers, switches, and the like.

As depicted in FIG. 1, network attached device 102 may include a device that receives information from network 110 or devices (not depicted) within network 110 and/or transmits information to network 110. For use in conjunction with a network processor as described below, data processing network 110 may be implemented as a packet switched network. In a packet switched network, units of information referred to as packets are routed between network nodes over network links shared with other traffic. Packet switching may be desirable for its optimization of available bandwidth, its ability to reduce perceived transmission latency, and its availability or robustness. In packet switched networks including the Internet, information may be split up into discrete packets. Each packet may include a complete destination address and is individually routed to its destination.

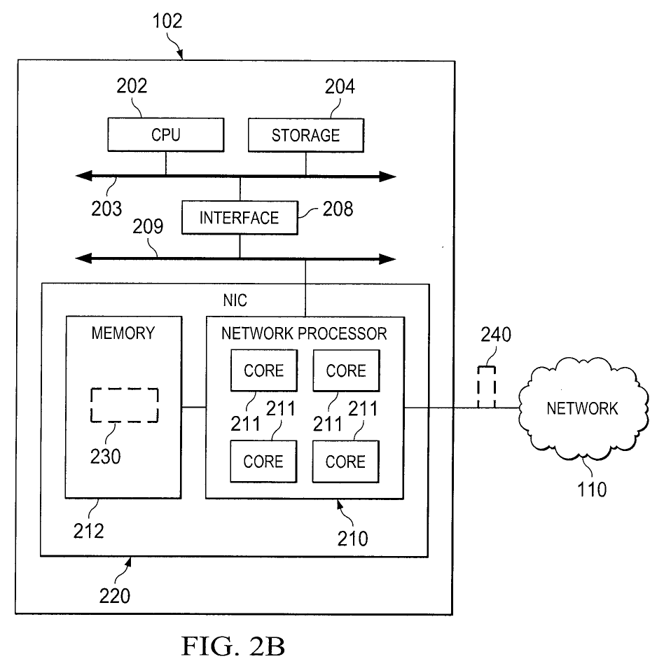

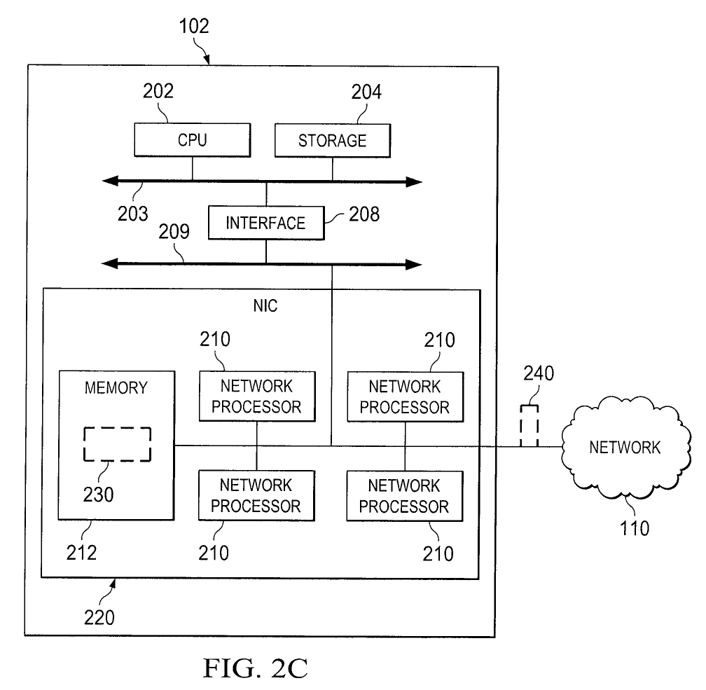

FIG. 2A illustrates a block diagram of selected elements of an example of a network attached device 102, in accordance with embodiments of the present disclosure. The implementation of network attached device 102 as depicted in FIG. 2A may be representative of server class embodiments. In such embodiments, network attached device 102 may include a general purpose central processing unit (CPU) 202 and a special purpose or focused function network processor (NP) 210. CPU 202 may be coupled to a system bus 203 to which storage 204 is also operatively coupled. In certain embodiments, one or more intermediate interconnects or interconnect links may exist between CPU 202 and storage 204. Storage 204 may include volatile system memory (e.g., DRAM) of CPU 202 as well as any nonvolatile or persistent storage of network attached device 102. Persistent storage includes, but is not limited to, traditional magnetic storage medium such as hard disks.

As shown in FIG. 2A, a bridge or interface 208 may be coupled between system bus 203 and a peripheral or I/O bus 209. I/O bus 209 may include, as an example, a PCI (peripheral components interface) bus. In such embodiments, NP 210 and an NP memory 212 may be a part of an adapter card or other peripheral device such as a network interface card (NIC) 220. In other embodiments, however, network attached device 102 may be a stand-alone device such as a network router in which network processor 102 may represent the primary processing resource.

Regardless of the specific implementation, network attached device 102 may include an NP 210 that is responsible for at least a portion of the network packet processing and packet transmission performed by network attached device 102. NP 210 may be a special purpose integrated circuit designed to perform packet processing efficiently. NP 210 may include features or architectures to enhance and optimize packet processing independent of the network implementation or protocol. NP 210 may be used in various applications including, without limitation, as network routers or switches, firewalls, intrusion detection devices, intrusion prevention devices, and network monitoring systems as wells as in conventional Network Interface Cards to provide a network processing offload design. In certain embodiments, NP 210 may be configured as a multithreading processor.

As mentioned above, NP 210 may act as a dedicated purpose device that operates independently of the implementation and protocol specifics of network 110. In some embodiments, NP 210 may support a focused and limited set of operation codes (op codes) that modify packet data that is to be transmitted over network 110. In these embodiments, NP 210 may operate in conjunction with a data structure referred to herein as a packet transfer data structure (PTD) 230. A PTD 230 may be implemented as a relatively rigidly formatted data structure that includes information pertaining to various aspects of transmitting packets over a network. NP 210 may incorporate inherent knowledge of the PTD format. At least one PTD 230 may be stored in NP memory 212 at a location or address that is known by NP 210. NP 210 may retrieve a PTD 230 from NP memory 212 and generates one or more network packets 240 to transmit across network 110. NP 210 may generate network packets 240 based on information stored in PTD 230. As suggested earlier, some embodiments of NP 210 may locate packet data stored in a PTD 230, parse the packet data, and transmit the parsed data, substantially without modification, as a network packet 240. NP 210 may also include support for a processing a limited set of op codes, stored in PTD 230, that instruct NP 210 to modify PTD packet data in a specified way. The data modification operations may include, for example, incrementing, decrementing, and generating random numbers for a portion of the packet data as well as calculating and storing checksums according to various protocols.

FIG. 2B illustrates a block diagram of selected elements of an alternative embodiment of an example of a network attached device 102. In certain embodiments, the network attached device 102 depicted in FIG. 2B may be similar to the network attached device 102 of FIG. 2A, except that NP 210 as shown in FIG. 2B may comprise a multi-core processor or chip-level multiprocessor which may include a plurality of cores 211. Each core 211 may be configured to perform independently from other cores 211 as a network processor, but may share resources with other cores 211 (e.g., on-chip or off-chip memory, communications busses, etc.). In certain embodiments, one or more of cores 211 may be configured as a multithreading processor.

FIG. 2C illustrates a block diagram of selected elements of another alternative embodiment of an example of a network attached device. In certain embodiments, the network attached device 102 depicted in FIG. 2C may be similar to the network attached devices 102 of FIGS. 2A-2B, except that the network attached device 102 of FIG. 2C may include a plurality of NPs 210. Each NP 210 may be configured to perform independently from other NPs 210, but may share resources with other NPs 210 (e.g., off-chip memory, communications busses, etc.). In certain embodiments, one or more of NPs 210 may be configured as a multithreading processor.

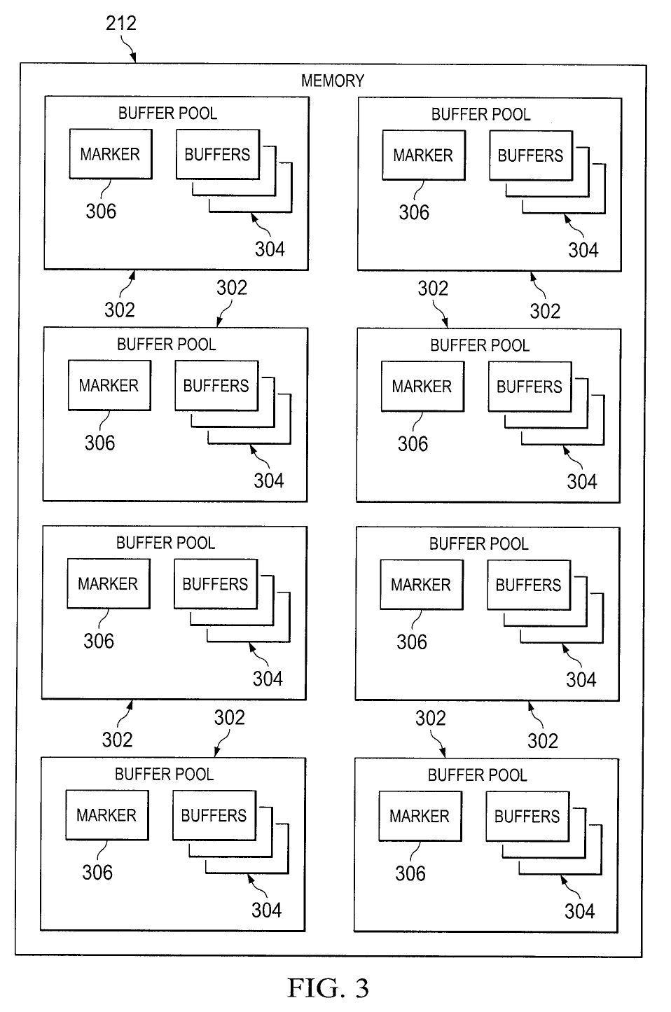

FIG. 3 illustrates a block diagram of selected elements of an example memory 212, in accordance with embodiments of the present disclosure. As depicted in FIG. 3, memory 212 may include a plurality of buffer pools 302. Each buffer pool 302 may include one of more buffers 304 for storing data associated with operations performed by a thread, NP 210, and/or core 211. Also as shown in FIG. 3, each buffer pool 212 may include a marker 306. Each marker 306 may include any suitable field, variable, or data structure configured to store information indicative of a particular thread, NP 210, or core 211 to which such marker 306's associated buffer pool 302 is allocated and/or assigned. Accordingly, marker 306 may indicate which of a particular thread, NP 210, and/or core 211 “owns” the associated buffer pool 302. A marker 306 may also indicate whether a particular buffer pool 302 is unallocated and/or unassociated with any thread, NP 210, and/or core 211. Any buffer pool 302 which is associated with a particular thread, NP 210, or core 211 may be considered a “local buffer pool” with respect to the particular thread, NP 210, or core 211. On the other hand, any buffer pool 302 which is not associated with any thread, NP 210, or core 211 may be considered a “global buffer pool.”

Referring again to FIGS. 2A-2C, in each of the embodiments set forth in FIGS. 2A-2C, each thread, NP 210, and core 211 may be configured to maintain a “buffer pool list.” The buffer pool list may comprise a database, table, and/or other suitable data structure that may be used to allow its associated thread, NP 210, or core 211 to maintain its local buffer pools 302. Such buffer pool list may include information indicative of local buffer pools 302 assigned and/or allocated to the buffer pool list's associated thread, NP 210, or core 211, as well as whether such local buffer pools 302 are currently in use, or whether such local buffer pools 302 are free (e.g., not in use).

For added clarity and simplicity, the term “processor” will be used for the balance of this disclosure to generally refer to a thread, NP 210, or core 211.

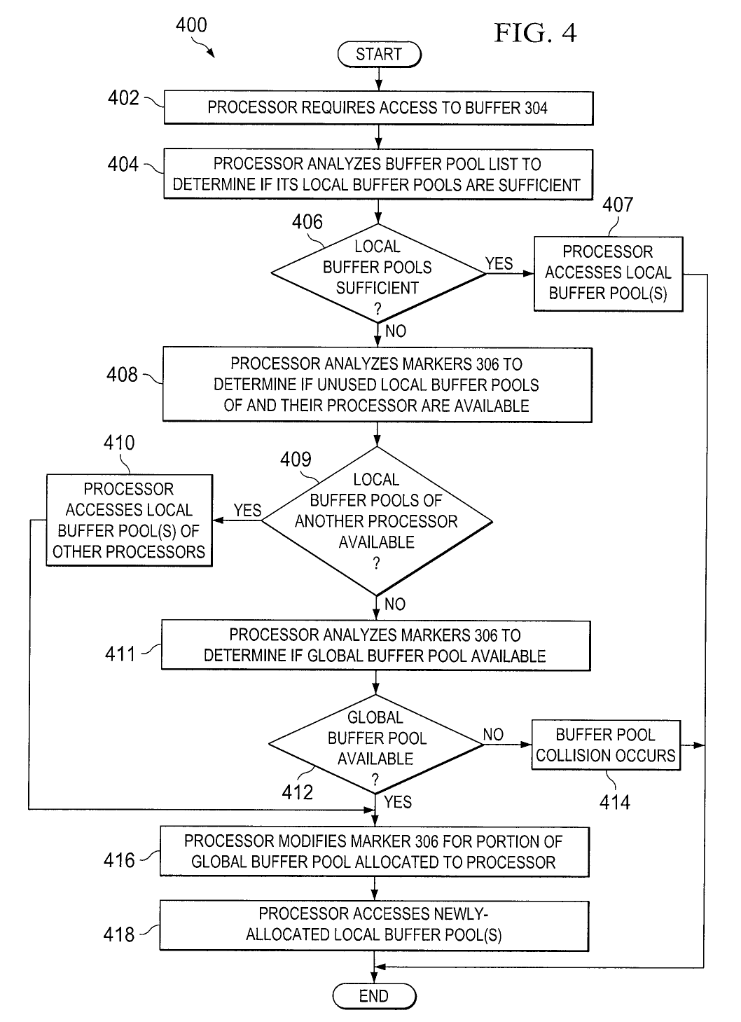

FIG. 4 illustrates a flow chart of an example method 400 for accessing a buffer pool 302 by a processor, in accordance with embodiments of the present disclosure. According to one embodiment, method 400 may begin at step 402. As noted above, teachings of the present disclosure may be implemented in a variety of configurations of data processing system 100. As such, the preferred initialization point for method 400 and the order of the steps 402-418 comprising method 400 may depend on the implementation chosen.

At step 402, a processor (e.g., thread, NP 210, or core 211) may determine that an instruction or process requires access to a buffer 304. At step 404, the processor may analyze its buffer pool list to determine whether the local buffer pools 302 associated with the processor are sufficient to satisfy the processor's buffer needs in connection with the instruction or process. Accordingly, if it is determined at step 406 that the processor's local buffer pools 302 are sufficient, method 400 may proceed to step 407. Otherwise, if it is determined at step 406 that the processor's local buffer pools 302 are not sufficient, method 400 may proceed to step 408.

At step 407, in response to a determination that the processor's local buffer pools 302 are sufficient, the processor may access one or more of its local buffer pools 302 to carry out the instruction or process. After completion of step 407, method 400 may end.

At step 408, in response to a determination that the processor's local buffer pools 302 are not sufficient, the processor may analyze markers 306 to determine if unused local buffer pools of another processor are available for use by the processor. Accordingly, if it is determined at step 409 that the unused local buffer pools of other processors are sufficient, method 400 may proceed to step 410. Otherwise, if it is determined at step 409 that the unused local buffer pools of other processors are not sufficient, method 400 may proceed to step 411.

At step 410, in response to a determination that the local buffer pools 302 of another processor are sufficient, the processor may access one or more of such local buffer pools 302 of other processors to carry out the instruction or process. After completion of step 410, method 400 may proceed to step 416.

At step 411, in response to a determination that local buffer pools 302 of other processors are not sufficient, the processor may analyze the markers 306 to determine if an unallocated global buffer pool 302 is available. Accordingly, if it is determined at step 412 that a global buffer pool 302 is unavailable, method 400 may proceed to step 414. Otherwise, if it is determined at step 412 that a global buffer pool 302 is available, method 400 may proceed to step 416.

At step 414, in response to a determination that a global buffer pool 302 is not available, a buffer pool collision occurs. Accordingly, the processor may either have to wait until one of its own local buffer pools becomes free, or wait until another processor releases its own local buffer pool to the overall global buffer pool. After completion of step 414, method 400 may end.

At step 416, in response to a determination that a global buffer pool 302 is available, one or more such global buffer pools 302 may be allocated to the processor. Accordingly the processor may modify the marker 306 associated with each such allocated buffer pool(s) 302 to indicate that such buffer pools are allocated the processor. In addition, the processor may also update its own buffer pool list to reflect that such newly-allocated buffer pools 302 are associated with the processor. At step 418, the processor may access the newly-allocated local buffer pool(s) 306 in connection with an instruction or process executing thereon. After completion of step 418, method 400 may end.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 400 may be completed in any suitable order.

Method 400 may be implemented using data processing system 100 or any other system operable to implement method 400. In certain embodiments, method 400 may be implemented partially or fully in software and/or firmware embodied in computer-readable media.

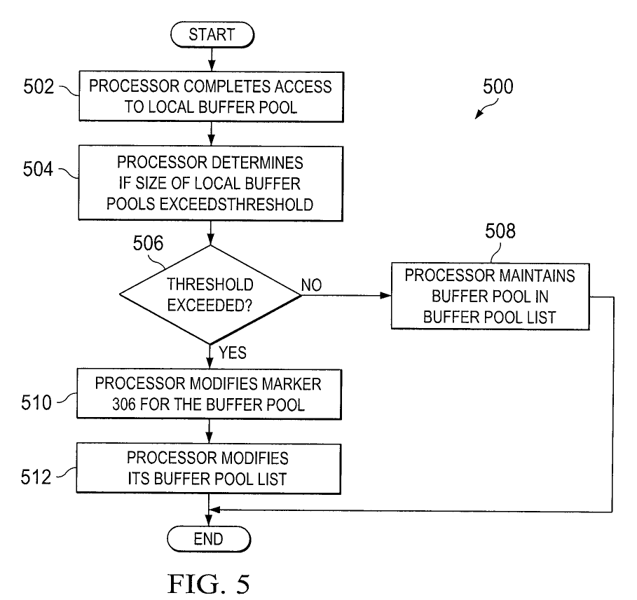

FIG. 5 illustrates a flow chart of an example method 500 for freeing a local buffer pool by a processor, in accordance with embodiments of the present disclosure. According to one embodiment, method 500 may begin at step 502. As noted above, teachings of the present disclosure may be implemented in a variety of configurations of data processing system 100. As such, the preferred initialization point for method 500 and the order of the steps 502-512 comprising method 500 may depend on the implementation chosen.

At step 502, a processor may complete its access to a local buffer pool 302 allocated to the processor. At step 504, the processor may determine if the aggregate size of its local buffer pools 302 exceeds a predetermined threshold. Such predetermined threshold may in effect place an upper limit on the aggregate size amount of local buffer pools 302 that may be allocated to a processor (unless such processor is presently accessing all of such local buffer pools, in which case the limit may not be applied until access is complete). Such predetermined threshold may be established in any suitable manner (e.g., set by manufacturer, set by user/administrator of data processing system 100, set dynamically by data processing system 100 or its components based on parameters associated with the operation of data processing system 100).

If it is determined at step 506 that the predetermined threshold is not exceeded, method 500 may proceed to step 508. Otherwise, if it is determined at step 508 that the predetermined threshold is exceeded, method 500 may proceed to step 510.

At step 508, in response to a determination that the predetermined threshold is not exceeded, the processor may maintain the local buffer pool 302 on its buffer pool list, and thus may later access the local buffer pool 302 if needed by another instruction or process.

At step 510, in response to a determination that the predetermined threshold is exceeded, the processor may modify marker 306 associated with the buffer pool 302 to indicate that it is no longer allocated to the processor, and thus, has been released to be a global buffer pool. At step 512, the processor may also modify its buffer pool list to indicate that the de-allocated buffer pool 302 is no longer a local buffer pool of the processor.

Although FIG. 5 discloses a particular number of steps to be taken with respect to method 500, method 500 may be executed with greater or lesser steps than those depicted in FIG. 5. In addition, although FIG. 5 discloses a certain order of steps to be taken with respect to method 500, the steps comprising method 500 may be completed in any suitable order.

Method 500 may be implemented using data processing system 100 or any other system operable to implement method 500. In certain embodiments, method 500 may be implemented partially or fully in software and/or firmware embodied in computer-readable media.

Using the methods and systems discussed in this disclosure, problems and disadvantages associated with traditional approached to multithreading and multiprocessing may be reduced or eliminated. Because global buffer pools are dynamically allocated to processors, the likelihood of contentions may decrease, while still allowing processors to access buffer pools not allocated to other processors. For example, in certain embodiments, upon initialization of data processing system 100, all buffer pools 302 may be designated as global. As processors require buffer pools, the unallocated global buffer pools may then be dynamically allocated to processors, and dynamically de-allocated back into the overall global pool. As another example, in other embodiments, upon initialization of data processing system 100, certain of buffer pools 302 may be allocated to individual processors and some buffer pools 302 may be designated as global. As processors require buffer pools, the unallocated global buffer pools may then be dynamically allocated to processors, and dynamically de-allocated back into the overall global pool.

It should be appreciated that while the discussion above focused primarily on network processors, that the above systems and methods may also be useful in general purpose processors and memories and caches associated therewith. It is also appreciated that portions of the present invention may be implemented as a set of computer executable instructions (software) stored on or contained in a computer-readable medium. The computer readable medium may include a non-volatile medium such as a floppy diskette, hard disk, flash memory card, ROM, CD ROM, DVD, magnetic tape, or another suitable medium. Further, it will be appreciated by those skilled in the art that there are many alternative implementations of the invention described and claimed herein. It will be apparent to those skilled in the art having the benefit of this disclosure that the present invention contemplates the processing and encoding of network flows so that the encoded results accurately emulate the original network flows, but can be stored in significantly less memory than would otherwise be required for storing the original network flows. Once encoded, characteristics and attributes of the stored network flows may be examined and, if desired, manipulated to facilitate different network flows to be emulated. The stored network flows may be decoded and transmitted for purposes of testing network components. It is understood that the forms of the invention shown and described in the detailed description and the drawings are to be taken merely as presently preferred examples and that the invention is limited only by the language of the claims.

What is claimed is:

1. A system comprising:
a plurality of processors; and
a memory communicatively coupled to each of the plurality of processors, the memory having a plurality of portions, and each portion having a marker indicative of whether such portion is associated with one of the plurality of processors;
wherein at least one of the plurality of processors is configured to maintain an associated data structure, the data structure indicative of the portions of the memory associated with the processor.

2. A system according to claim 1, wherein each marker is further indicative of one of the plurality of processors associated with the portion of memory.

3. A system according to claim 1, wherein at least one of the plurality of processors is configured to:
analyze its associated data structure to determine if the portions of memory associated with the processor are sufficient to store data associated with an operation of the processor;
store data associated with the operation in the portions of the memory associated with the processor if the portions of memory associated with the processor are sufficient; and
if the portions of memory associated with the processor are not sufficient:
determine if at least one portion of the memory is unassociated with any of the plurality of processors; and
store data associated with the operation in the at least one unassociated portion of the memory.

4. A system according to claim 3, wherein the at least one processor is configured to, if the portions of memory associated with the processor are not sufficient, modify the marker of the at least one unassociated portion of the memory to indicate that the at least one unassociated portion of the memory is associated with the at least one processor.

5. A system according to claim 3, wherein the at least one processor is configured to, if the portions of memory associated with the processor are not sufficient, modify its associated data structure to indicate that the at least one processor is associated with the at least one unassociated portion of the memory.

6. A system according to claim 3, wherein the at least one processor is configured to determine if the at least one portion of the memory is unassociated with any of the plurality of processors by analyzing the plurality of markers.

7. A system according to claim 1, wherein the plurality of processors includes at least one of a thread, a core, or a monolithic processor.

8. A system according to claim 1, wherein the plurality processors includes at least one of a general purpose processor and a network processor.

9. A method for managing a memory communicatively coupled to a plurality of processors, comprising:
analyzing a data structure associated with a processor to determine if one or more portions of memory associated with the processor are sufficient to store data associated with an operation of the processor;
storing data associated with the operation in the one or more portions of the memory associated with the processor if the portions of memory associated with the processor are sufficient; and
if the portions of memory associated with the processor are not sufficient:
determining if at least one portion of the memory is unassociated with any of the plurality of processors; and
storing data associated with the operation in the at least one unassociated portion of the memory.

10. A method according to claim 9, further comprising modifying a marker associated with the at least one unassociated portion of the memory to indicate that the at least one unassociated portion of the memory is associated with the processor if the one or more portions of memory associated with the processor are not sufficient.

11. A method according to claim 9, further comprising modifying the data structure associated with the processor to indicate that the processor is associated with the at least one unassociated portion of the memory.

12. A method according to claim 9, further comprising analyzing a plurality of markers, each marker associated with a portion of the memory and indicative of whether such portion is associated with one of the plurality of processors, to determine if the at least one portion of the memory is unassociated with any of the plurality of processors.

13. A method according to claim 9, wherein the processor includes at least one of a thread, a core, or a monolithic processor.

14. A method according to claim 9, wherein the plurality processors includes at least one of a general purpose processor and a network processor.

15. A network processor, configured to be communicatively coupled to at least one other network processor and a memory, and further configured to:
analyze a data structure associated with the network processor to determine if one or more portions of memory associated with the network processor are sufficient to store data associated with an operation of the network processor;
store data associated with the operation in the one or more portions of the memory associated with the network processor if the portions of memory associated with the network processor are sufficient; and
if the portions of memory associated with the network processor are not sufficient:
determine if at least one portion of the memory is unassociated with any of the at least one other network processor; and
store data associated with the operation in the at least one unassociated portion of the memory.

16. A network processor according to claim 15, the network processor further configured to modify a marker associated with the at least one unassociated portion of the memory to indicate that the at least one unassociated portion of the memory is associated with the processor if the one or more portions of memory associated with the processor are not sufficient.

17. A network processor according to claim 15, further comprising modifying the data structure associated with the processor to indicate that the network processor is associated with the at least one unassociated portion of the memory.

18. A network processor according to claim 15, further comprising analyzing a plurality of markers, each marker associated with a portion of the memory and indicative of whether such portion is associated with the network processor or the at least one other processor, to determine if the at least one portion of the memory is unassociated with the at least one other network processor.

19. A network processor according to claim 15, wherein the network processor includes at least one of a network processor thread, a core of a multicore network processor, or a monolithic network processor.

20. A network processor according to claim 15, wherein one or more portions of memory each include a buffer pool.
